(19) United States
(12) Patent Application Publication
(10) Pub. No.: US 2012/0151765 A1
(43) Pub. Date: Jun. 21, 2012

(54) LEAD CONNECTOR END WITH INTEGRATED SHUNT

(75) Inventors: Benjamin F. James, IV, Canyon Country, CA (US); Deepak Agrawal, Valencia, CA (US)

(73) Assignee: PACESETTER, INC., Sylmar, CA (US)

(21) Appl. No.: 12/975,147

(22) Filed: Dec. 21, 2010

(51) Int. Cl. H01R 43/04

(52) U.S. Cl. 29/882

(57) ABSTRACT

A lead connector end is disclosed herein. The lead connector end may include a generally cylindrical body of unitary construction. The unitary construction may include an electrically non-conductive material extending between three ring contacts imbedded in the electrically non-conductive material. The three ring contacts are offset from each other along a longitudinal length of the unitary body. An electrical conductor extends between two of the three ring contacts and is recessed within an outer circumferential surface of the generally cylindrical body of unitary construction. The electrical conductor is electrically connected to the two of the three ring contacts and forms an integral shunt between the two of the three ring contacts.

### FIELD OF THE INVENTION

The present invention relates to medical apparatus and methods. More specifically, the present invention relates to implantable medical leads and the lead connector ends of such leads.

### BACKGROUND OF THE INVENTION

An implantable medical lead typically includes one or more lead connector ends on the proximal end of the lead. Lead connector ends are used to mechanically and electrically couple a proximal end of a lead to the header or connector bores of a pacemaker, implantable cardioverter defibrillator (“ICD”) or other type of pulse generator.

IS4 and DF4 lead connector ends are generally iso-diametric and have multiple electrical contacts in the form of contact rings and a contact pin. IS4 and DF4 lead connector ends are advantageous for a number of reasons, including, for example, that a single such connector end can replace the need for multiple connector ends.

Implantable medical leads such as integrated bipolar high voltage leads require an electrical shunt between the right ventricle (“RV”) shock coil circuit and the sensing/pacing ring electrode circuit. Integrated bipolar high voltage leads known in the art have multiple lead connector ends and incorporate a shunt within a trifurcation boot using a crimp connection between the RV cables and the outer coil/ring electrode circuit. This crimp provides the required shunt.

It is desirable to employ IS4 and DF4 lead connector ends with integrated bipolar high voltage leads. However, IS4 and DF4 lead connector ends do not have three connector ends and, therefore, cannot incorporate a shunt with a trifurcation boot and crimp connection.

There is a need in the art for an IS4 and DF4 lead connector end that is compatible with integrated bipolar high voltage leads.

### BRIEF SUMMARY OF THE INVENTION

A method of manufacturing a lead connector end of an implantable medical lead is disclosed herein. In one embodiment, the method includes: providing a first ring contact, a second ring contact and a third ring contact in a spaced apart arrangement, each of the ring contacts generally centered about a common longitudinal axis; providing a first conductor, a second conductor and a third conductor; assembling a ring assembly by causing: 1) the first conductor to be electrically and mechanically directly connected to both of the first ring contact and the second ring contact; 2) the second conductor to be electrically and mechanically directly connected to the second ring contact; and 3) the third conductor to be electrically and mechanically directly connected to the third ring contact; and over-molding the ring assembly to form a body of the lead connector end.

In one version of the embodiment of the method, at least one of the first, second or third conductor includes a pin conductor. In one version of the embodiment of the method, at least one of the first, second and third conductor is a wire or multi-filar conductor.

In one version of the embodiment of the method, the first ring contact, the second ring contact and the third ring contact are, respectively, a proximal ring contact, a middle ring contact and a distal ring contact. In one version of the embodiment of the method, the first ring contact, the second ring contact and the third ring contact are, respectively, a RV electrode ring contact, a RV shock coil ring contact and a SVC shock coil ring contact.

In one version of the embodiment of the method, assembling the ring assembly further includes causing each of the conductors to extend into a center region of at least one of the conductors. In one version of the embodiment of the method, electrically and mechanically directly connecting the first conductor to the first ring contact includes at least one of welding, brazing, soldering or crimping the first conductor directly to at least a portion of the first ring contact. The at least a portion of the first ring contact may include a member radially inwardly projecting into a center region of the first ring contact.

In one version of the embodiment of the method, the body is a body for an IS4 or DF4 lead connector end.

An implantable integrated bi-polar medical lead is also disclosed herein. In one embodiment, the lead includes a tubular body, a distal shock coil, a proximal shock coil, a lead connector end, a first conductor, and a second conductor. The tubular body includes a distal end and a proximal end. The distal shock coil is supported on the tubular body proximal of the distal end. The proximal shock coil is supported on the tubular body proximal the distal shock coil. The lead connector end includes cylindrical body with a proximal end and a distal end, the lead connector end further including three ring contacts imbedded in the cylindrical body and longitudinally spaced apart from each other along the cylindrical body, the distal end of the lead connector end being coupled to the proximal end of the tubular body. The first conductor extends through the tubular body and lead connector end and directly electrically connected to two ring contacts of the three ring contacts. The second conductor extends through the tubular body and lead connector end and directly electrically connected to the distal shock coil and one ring contact of the two ring contacts.

In one version of the lead embodiment, a third conductor extends through the tubular body and lead connector end and directly electrically connects to the proximal shock coil and one ring contact that is not the two ring contacts of the three ring contacts. In one version of the lead embodiment, the two ring contacts of the three ring contacts are a proximal ring contact and a middle ring contact, the one ring contact of the two ring contacts is the middle ring contact, and the one ring contact that is not the two ring contacts of the three ring contacts is a distal ring contact. In one version of the lead embodiment, the two ring contacts of the three ring contacts are a RV electrode ring contact and a RV shock coil ring contact, the one ring contact of the two ring contacts is the RV shock coil ring contact, and the one ring contact that is not the two ring contacts of the three ring contacts is a SVC shock coil ring contact.

In one version of the lead embodiment, the distal shock coil is configured to act as both a RV ring electrode and a RV shock electrode. In one version of the lead embodiment, the first conductor directly electrically connecting to the two ring contacts of the three ring contacts forms an internal electrical shunt between the two ring contacts of the three ring contacts.

In one version of the lead embodiment, the first conductor includes: a single wire conductor or multi-filar cable conductor extending through the tubular body; and a conductor pin extending through the lead connector end, a distal end of the conductor pin being connected to a proximal end of the single wire conductor or multi-filar conductor. In one version of the lead embodiment, the lead connector is at least similar to an IS4 or DF4 lead connector end.

The lead of claim 10, further comprising: a tip electrode near a distal end of the tubular body; a pin contact proximally extending from a proximal end of the lead connector end; and a helical coil conductor extending between the tip electrode and the pin contact.

A lead connector end is also disclosed herein. In one embodiment, the lead connector end includes a generally cylindrical body of unitary construction. The unitary construction includes an electrically non-conductive material extending between three ring contacts imbedded in the electrically non-conductive material. The three ring contacts are offset from each other along a longitudinal length of the unitary body. An electrical conductor extends between two of the three ring contacts and is recessed within an outer circumferential surface of the generally cylindrical body of unitary construction.

In one version of the connector end embodiment, the electrical conductor includes a pin conductor. In one version of the connector end embodiment, the two of the three ring contacts are a proximal ring contact and a middle ring contact. In one version of the connector end embodiment, the two of the three ring contacts are a RV ring electrode ring contact and a RV shock coil ring contact. In one version of the connector end embodiment, a pin contact extends proximally from a proximal end of the lead connector end.

While multiple embodiments are disclosed, still other embodiments of the present invention will become apparent to those skilled in the art from the following Detailed Description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side view of an electrophysiology device and, more specifically, an implantable medical lead.

FIG. 2 is a side view of the lead connector end of FIG. 1 extending proximally from a proximal end 14 of the lead body 12.

FIG. 3 is an isometric view of the lead connector end of FIG. 2, less the boot and proximal end of the lead body and showing the conductors that extend through the lead body from the lead connector end.

FIG. 4 is an isometric view of the lead connector end of FIGS. 2 and 3 with the body of the lead connector end shown in phantom line and the pin contact, helical conductor and proximal end of the lead body hidden for clarity purposes.

FIG. 5 is an isometric view of the proximal and distal ring contacts of the lead connector end of FIGS. 2-4.

FIG. 6 is an isometric view of the middle ring contact of the lead connector end of FIGS. 2-4.

FIG. 7 is a flow chart illustrating a method of assembly the integrated bi-polar lead.

### DETAILED DESCRIPTION

A lead connector end 18, which has an integral shunt 70 that allows the lead connector end 18 to be employed with an integrated bipolar high voltage lead, is disclosed herein. In one embodiment, the lead connector end 18 is an 184 or DF4 lead connector end. The integral shunt 70 includes an electrical pathway between a proximal ring contact 2a and a middle ring contact 2b of an 184 or DF4 lead connector end 18 of an integrated bipolar high voltage lead 10.

Specifically, in one embodiment, the electrical conductor 32a of a pacing/sensing circuit typically associated with a ring electrode of a standard lead is electrically and mechanically connected directly to both a proximal ring contact 2a (i.e., the ring contact normally associated with a pacing/sensing ring electrode) and a middle ring contact 2b (i.e., the ring contact normally associated with a right ventricle (“RV”) shocking coil). The shunt 70 established between the proximal ring contact 2a and the middle ring contact 2b of an 184 or DF4 lead connector end 8 allows an integrated bipolar high voltage lead 10 to benefit from having a 184 or DF4 lead connector end while having a dual function distal coil 24 capable of both pacing/sensing, like a common ring electrode, and shock, like a common RV shock coil.

The following description presents preferred embodiments of the lead connector end 18 and represents the best mode contemplated for practicing the lead connector end 18. This description is not to be taken in a limiting sense, but is made merely for the purpose of describing the general principles of the lead connector end 18, the scope of the lead connector end being defined by the appended claims.

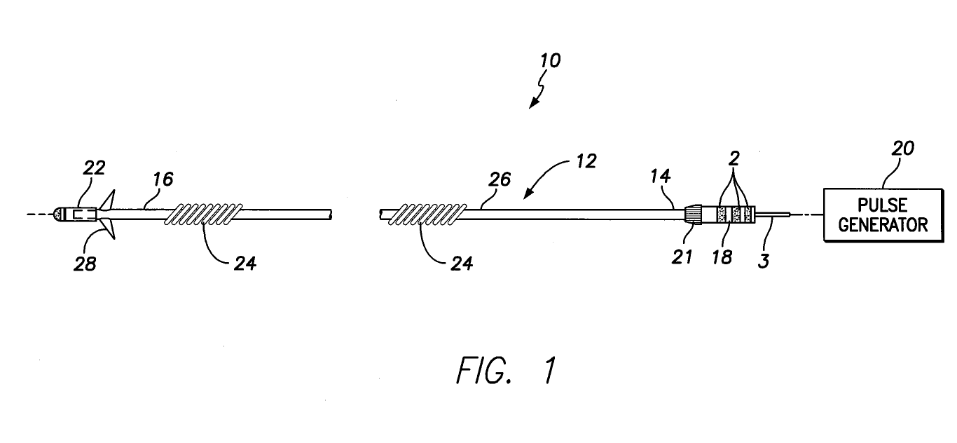

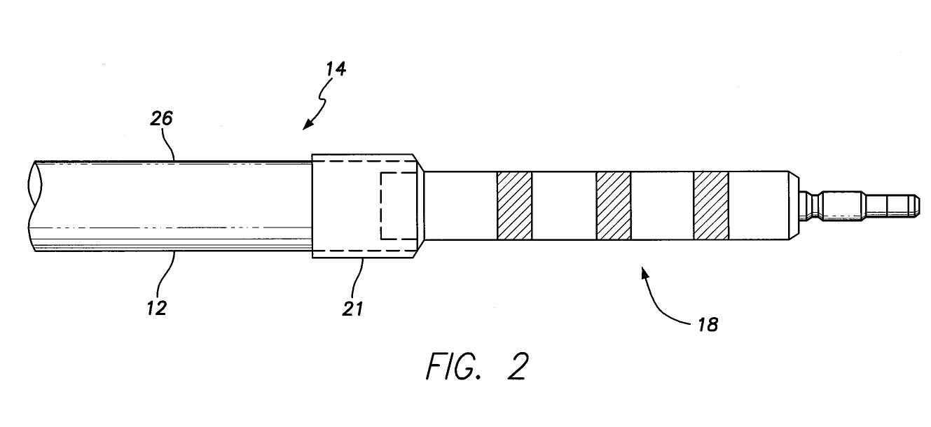

FIG. 1 is a side view of an implantable medical lead 10, which may be any type of an integrated bipolar high voltage lead 10, including, for example, a tachycardia, RV, or other type of lead. As shown in FIG. 1, the lead 10 includes a tubular body 12 having a proximal end portion 14 and a distal end portion 16. The proximal end portion 14 of the tubular body 12 carries a connector assembly 18 for coupling the tubular body 12 to a receptacle on a pulse generator 20 such as, for example, a pacemaker or an ICD. Depending on its type, the lead connector end 18 may include one or more ring contacts 2 and a pin contact 3, the contacts 2, 3 contacting complementary contacts in the pulse generator 20 when the lead connector end 18 is received in the pulse generator 20. For example and as discussed with respect to FIG. 2 below, when the lead connector end 18 is an IS4/DF4 lead connector end 18, there may be three ring contacts 2 and a pin contact 3. A flex-boot 21 may be located at the transition between the distal end of the lead connector 18 and the proximal end of the lead body 12 to reduce the impact of flexing at this location and the likelihood of failure of the lead body or its electrical conductors due to flex fatigue.

The distal end portion 16 of the tubular body 12 carries a tip electrode 22 and a distal coil 24 proximal of the tip electrode and spaced apart therefrom. The distal coil 24 serves as an integrated ring electrode and shock coil that can both pace/sense when acting as a sensing electrode and shock when acting like a cardioverting and/or defibrillating shock coil. Proximal to the distal coil 25 is a proximal coil 24 supported on the tubular body 12. The proximal coil 25 serves as a shock coil that can shock to act like a cardioverting and/or defibrillating shock coil. Thus, in one embodiment, the distal shock coil 24 may act as both a sensing/pacing electrode and a RV shock coil, and the proximal shock coil 25 may act as a superior vena cava (“SVC”) shock coil. While the lead 10 depicted in FIG. 1 is depicted as a passive fixation lead, in other embodiments, the lead 10 may be configured for active fixation, even being equipped at the distal end with a helix anchor or other type of active fixation feature.

The tubular body 12 may be adapted to transmit stimulating and/or sensed electrical signals between the connector assembly 18, on the one hand, and the tip electrode 22 and coils 24, 25, on the other. For example, the tubular body 12 may have one or more conductors (e.g., cable conductors, helical conductors, etc.) longitudinally extending through the tubular body 12 between a contact 2, 3 and a respective electrode 22 or coil 24, 25, thereby placing the contact 2, 3 and respective electrode 22 or coil 24, 25 in electrical communication.

By way of example and not limitation, the distal end portion 16 of the tubular body 12 of the lead 10 may have a diameter of about (7F) to about (8F). In other embodiments, the lead diameter may be less than 7F or greater than 8F. The tubular body 12 may include a tubular insulating sheath or housing 26 of a suitable insulative biocompatible biostable material such as, for example, silicone rubber, polyurethane, silicone rubber—polyurethane—copolymer (“SPC”) or other suitable elastomer, extending the entire length of the tubular body 12.

The housing 26 may include along the distal end portion of the lead a plurality of rearwardly projecting tines 28 functioning, as is well know in the art, to interlock in the trabeculae within the heart and thereby prevent displacement of the distal end portion 16 once the lead 10 is implanted. Although tines are the preferred anchoring features for purposes of the present lead 10, it will be understood by those skilled in the art that fins, a screw-in helix, or some other suitable active fixation anchoring features may be used instead. Also, the lead may be configured for passive fixation via, for example, one or more S-shaped bends in the tubular body 12 along the distal end portion, and may be without tines or active fixation features. The S-shaped bends may bias against the walls of the coronary sinus region to maintain the lead 10 in position.

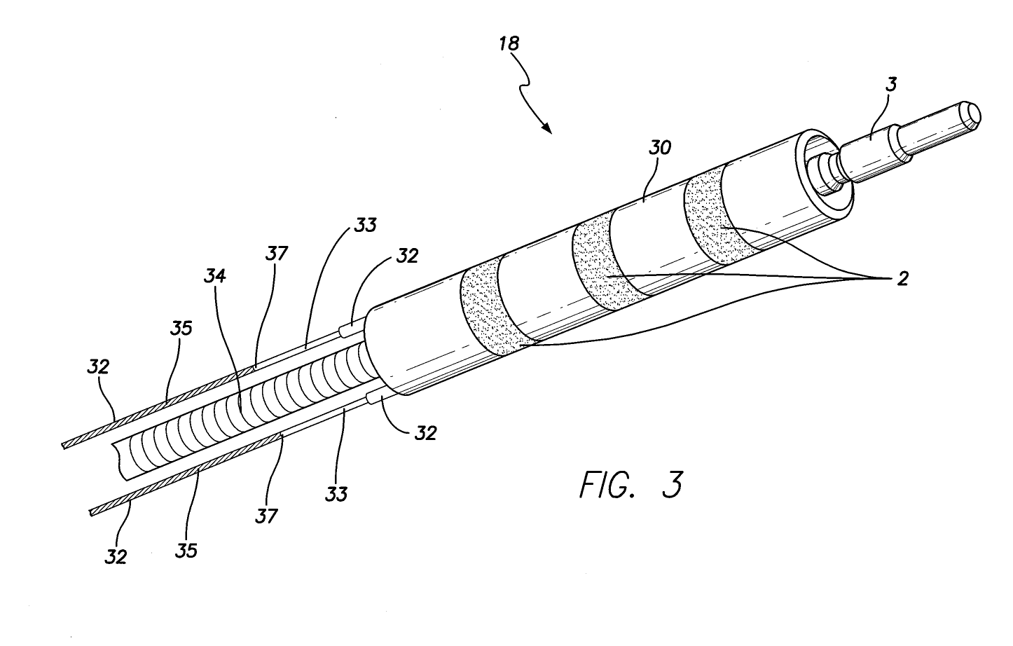

For a detailed discussion regarding the configuration of a lead connector end 18, which for the sake of the following description may be an IS4/DF4 lead connector end 18, reference is made to FIGS. 2 and 3. FIG. 2 is a side view of the lead connector end 18 of FIG. 1 extending proximally from a proximal end 14 of the lead body 12, and FIG. 3 is an isometric view of the same lead connector end 18 of FIG. 2, less the boot 21 and proximal end 14 of the lead body 12 and showing the conductors 32, 34 that extend through the lead body 12 from the lead connector end 18. While the lead connector end 18 is discussed in the following description in the context of an IS4/DF4 lead connector end 18, the novel features of the lead connector end 18 are equally applicable to other types of lead connector ends. Accordingly, the lead connector end features and method of manufacture should not be limited to IS4/DF4 lead connector ends, but should be interpreted to be applicable to other types of lead connector ends.

As shown in FIG. 2, the IS4/DF4 lead connector end 18 may have three ring contacts 2, a pin contact 3 and a connector body 30. The connector body 30 may be formed of an electrically non-conductive polymer material (e.g., tecothane, polyetheretherketone (“PEEK”), polysulfone, etc.) or other type of electrically non-conductive material. The ring contacts 2 may be located along the connector body 30 in a spaced-apart fashion along the longitudinal length of the connector body 30. The pin contact 3 may extend proximally from the proximal end of the connector body 30, and the connector body 30 may extend proximally from the proximal end 14 of the lead tubular body 12.

As can be understood from FIG. 3, a conductor 32 may extend distally through the connector body 30 from each respective ring contact 2 and into the lead body 12 to electrically connect to a respective electrode or coil supported on the lead body. A helical conductor 34, which may define a central lumen that extends into a central lumen of the pin contact 3, may extend distally through the connector body 30 from the pin contact 3 and further extend through the lead body to the tip electrode.

In one embodiment as can be understood from FIG. 3, the conductor 32 extending through the lead connector end and lead body may be a two part conductor 32. For example, the portion of the conductor 32 extending through and distally out of the lead connector end 18 may be pin conductor 33 (e.g., a generally rigid wire or generally rigid non-filar electrically conductive member), while the portion of the conductor 32 extending through the lead body to the respective electrode or coil may be a wire or multi-filar cable conductor 35. The two portions of the conductor may be connected via a connection 37 formed by welding, brazing, soldering, crimping, etc. such that the distal end of the pin conductor 33 is electrically and mechanically directly connected to the proximal end of a wire or multi-filar cable conductor 35.

In other embodiments, the conductor 32 may extend as a single piece conductor through the lead connector 18 and lead body 12 as a wire or multi-filar cable conductor.

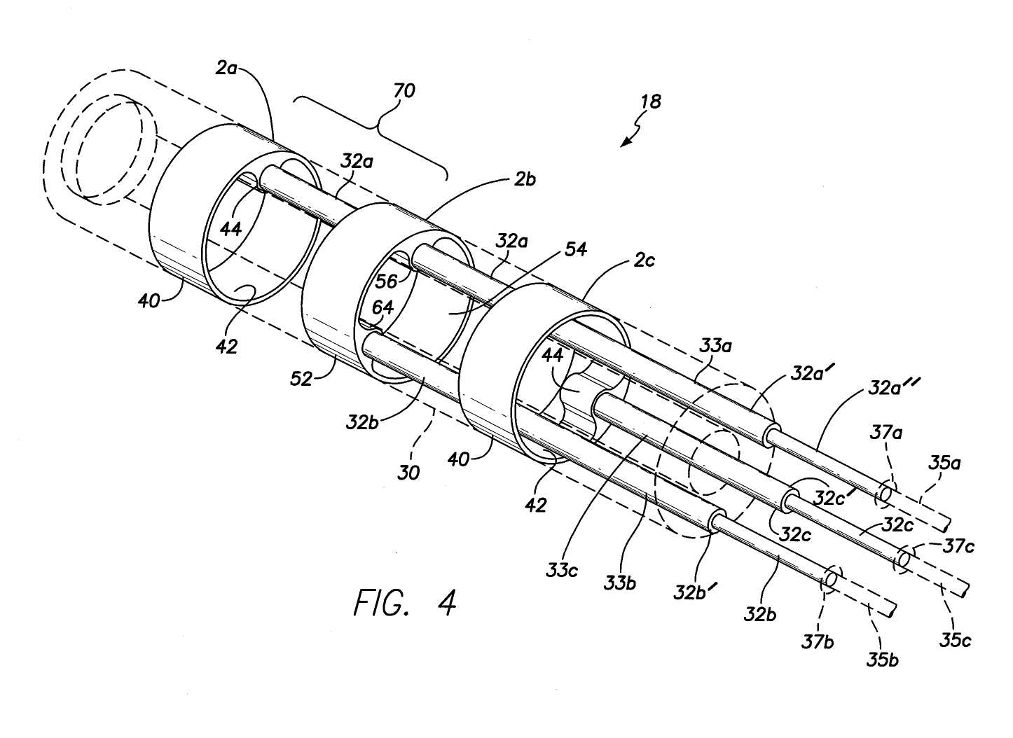

For a discussion of the conductor arrangement within the lead connector end 18, reference is made to FIG. 4, which is an isometric view of the lead connector end 18 of FIGS. 2 and 3 with the body 30 of the lead connector end shown in phantom line and the pin contact 3, helical conductor 34 and proximal end 14 of the lead body 12 hidden for clarity purposes. As shown in FIG. 4 and already mentioned above with respect to FIGS. 2 and 3, the connector end body 30 supports three ring contacts that are spaced longitudinally along the body 30 from each other and may, for purposes of this discussion, be called the proximal ring contact 2a, the middle ring contact 2b and the distal ring contact 2c.

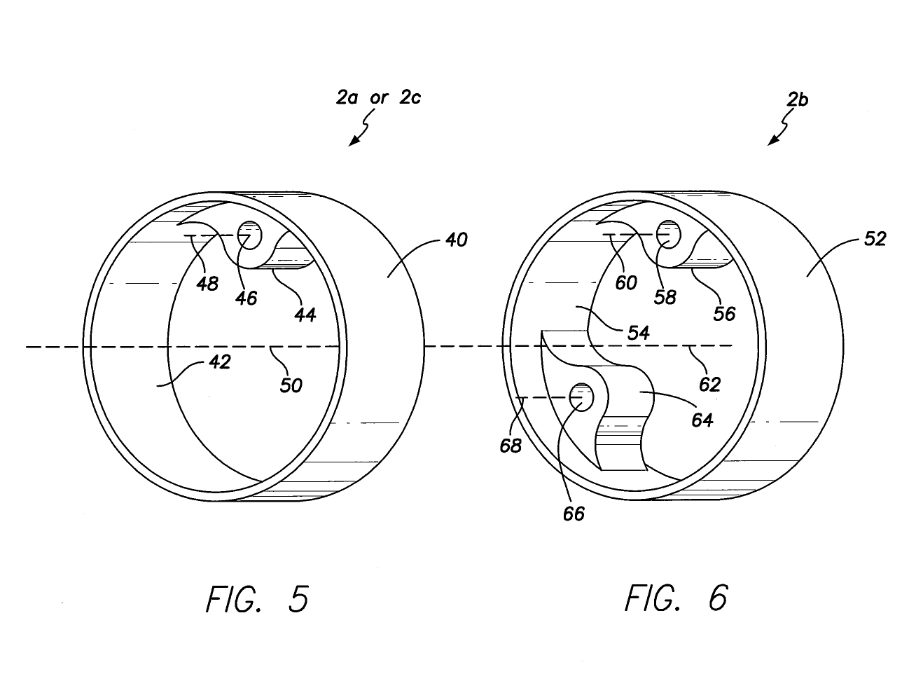

As can be understood from FIG. 4 and more fully depicted in FIG. 5, which is an isometric view of the proximal and distal ring contacts 2a, 2c of the connector 18 of FIGS. 2-4, the proximal and distal ring contacts 2a, 2c are each ring shaped and include an outer circumferential or cylindrical surface 40 and an inner circumferential or cylindrical surface 42. A conductor receiving member 44 radially inwardly projects from the inner surface 42 and includes a hole 46 that extends through the member 44 distal-proximal. The hole 46 has a center axis 48 that is generally parallel to the center axis 50 of the ring 2a, 2c, the center axis of the ring being generally coaxial with the longitudinal axis of the connector body 30.

As can be understood from FIG. 4 and more fully depicted in FIG. 6, which is an isometric view of the middle ring contact 2b of the connector 18 of FIGS. 2-4, the middle contact 2b is ring shaped and includes an outer circumferential or cylindrical surface 52 and an inner circumferential or cylindrical surface 54. A first conductor receiving member 56 radially inwardly projects from the inner surface 54 and includes a hole 58 that extends through the member 56 distal-proximal. The hole 58 has a center axis 60 that is generally parallel to the center axis 62 of the ring 2b, the center axis of the ring being generally coaxial with the longitudinal axis of the contact body 30.

A second conductor receiving member 64 also radially inwardly projects from the inner surface 54 and includes a hole 66 that extends through the member 64 distal-proximal. The hole 66 has a center axis 68 that is generally parallel to the center axis 62 of the ring 2b, the center axis of the ring being generally coaxial with the longitudinal axis of the connector body 30.

The second member 64 is circumferentially offset from the first member 56. In one embodiment, the second member may be separated from the first member on one side by approximately one third of the inner circumference and on the other side by approximately two thirds of the inner circumference.

The connector body 30 may be formed of an electrically non-conductive polymer material (e.g., tecothane, polyetheretherketone (“PEEK”), polysulfone, etc.) or other type of electrically non-conductive material. The ring contacts 2 may be formed of an electrically conductive material such as, for example, stainless steel, platinum, platinum-iridium, MP35N, etc.

As can be understood from FIG. 4, three conductors 32 extend proximally into the connector body 30 from the lead body 12 to mechanically and electrically couple to one or more of the ring contacts 2a, 2b, 2c. Specifically, a first conductor 32a, which extends proximally through the lead body 12 from a point near but not contacting the distal coil 24, passes through the interior of the distal ring contact 2c, through the hole 58 of the first member 56 of the middle ring contact 2b, and terminates in the hole 46 of the member 44 of the proximal ring contact 2a. The first conductor 32a, while not actually connected to any of the electrodes or coils, serves as a dummy conductor 32a to provide uniformity and symmetry for the flex and torque characteristics of the lead body that would not be present were one dummy conductor 32a not present.

As illustrated in FIG. 4, in one embodiment, the first conductor 32a may be a two-piece conductor having a distal portion formed of a multi-filar cable conductor or solid wire conductor 35a that is generally continuous through the lead body 12 from a point near, but not contacting the distal coil 24. The wire or cable conductor 35a has a proximal end that electrically and mechanically connects via a connection 37a (e.g., weld, brazed or soldered joint, crimp, etc.) to a distal end of a proximal portion, which is a pin conductor 33a (e.g., a generally rigid electrically conductive member). The pin conductor 33a extends at least generally continuous through the connector body 30 to the proximal ring 2a.

In another embodiment, the first conductor 32a may be a single-piece conductor in that a multi-filar cable conductor or solid wire conductor extends generally continuous through the lead body and lead connector from the distal coil 24 to the proximal ring 2a. In other words, the single-piece conductor does not employ a conductor.

In one embodiment, regardless of whether the first conductor 32a is a two-piece or single-piece conductor 32a, the first conductor 32a includes an electrically insulating jacket 32a′ surrounding an electrically conductive core 32a″. The jacket 32a′ prevents the core 32a″ from electrically contacting the distal ring contact 2c. However, the jacket 32a′ is missing from the core 32a″ where the conductor 32a passes through the holes 44, 56. Thus, the electrically conductive core 32a″ is electrically and mechanically (e.g., via welding, brazing, crimping, etc.) connected to the surfaces defining the holes 44, 56 such that the core 32a″ is electrically and mechanically connected to the proximal ring contact 2a and the middle ring contact 2b.

A second conductor 32b, which extends proximally through the lead body 12 from the distal coil 24, passes through the interior of the distal ring contact 2c and terminates in the hole 66 of the second member 64 of the middle ring contact 2b. As illustrated in FIG. 4, in one embodiment, the second conductor 32b may be a two-piece conductor having a distal portion formed of a multi-filar cable conductor or solid wire conductor 35b that is generally continuous through the lead body 12 from the distal coil 24. The wire or cable conductor 35b has a proximal end that electrically and mechanically connects via a connection 37b (e.g., weld, brazed or soldered joint, crimp, etc.) to a distal end of proximal portion, which is a pin conductor 33b (e.g., a generally rigid electrically conductive member). The pin conductor 33b extends at least generally continuous through the connector body 30 to the middle ring 2b.

In another embodiment, the second conductor 32b may be a single-piece conductor in that a multi-filar cable conductor or solid wire conductor extends generally continuous through the lead body and lead connector from the distal coil 24 to the middle ring 2b. In other words, the single-piece conductor does not employ a pin conductor.

In one embodiment, regardless of whether the second conductor 32b is a two-piece or single-piece conductor 32b, the second conductor 32b includes an electrically insulating jacket 32b′ surrounding an electrically conductive core 32b″. The jacket 32b′ prevents the core 32b″ from electrically contacting the distal ring contact 2c. However, the jacket 32b′ is missing from the core 32b″ where the conductor 32b passes through the hole 66. Thus, the electrically conductive core 32b″ is electrically and mechanically (e.g., via welding, brazing, crimping, etc.) connected to the surface defining the hole 64 such that the core 32b″ is electrically and mechanically connected to the middle ring contact 2b.

A third conductor 32c, which extends proximally through the lead body 12 from the proximal coil 25, terminates in the hole 46 of the member 44 of the distal ring contact 2c. As illustrated in FIG. 4, in one embodiment, the third conductor 32c may be a two-piece conductor having a distal portion formed of a multi-filar cable conductor or solid wire conductor 35c that is generally continuous through the lead body 12 from the proximal coil 25. The wire or cable conductor 35c has a proximal end that electrically and mechanically connects via a connection 37c (e.g., weld, brazed or soldered joint, crimp, etc.) to a distal end of proximal portion, which is a pin conductor 33c (e.g., a generally rigid electrically conductive member). The pin conductor 33c extends at least generally continuous through the connector body 30 to the distal ring 2c.

In another embodiment, the third conductor 32c may be a single-piece conductor in that a multi-filar cable conductor or solid wire conductor extends generally continuous through the lead body and lead connector from the proximal coil 25 to the distal ring 2c. In other words, the single-piece conductor does not employ a pin conductor.

In one embodiment, regardless of whether the third conductor 32c is a two-piece or single-piece conductor 32c, the third conductor 32c includes an electrically insulating jacket 32c′ surrounding an electrically conductive core 32c″. The jacket 32c′ is missing from the core 32c″ where the conductor 32c passes through the hole 46. Thus, the electrically conductive core 32c″ is electrically and mechanically (e.g., via welding, brazing, crimping, etc.) connected to the surface defining the hole 46 such that the core 32c″ is electrically and mechanically connected to the distal ring contact 2c.

As can be understood from the preceding discussion and FIG. 4, in one embodiment, the first and second conductors 32a, 32b are both electrically and mechanically directly connected to the middle ring contact 2b, the first conductor 32a is electrically and mechanically directly connected to the proximal ring contact 2a, and the third conductor 32c is electrically and mechanically directly connected to the distal ring contact 2c.

In one embodiment, the proximal ring contact 2a is part of the pacing/sensing circuit of the pulse generator 20 and sees the electrical signals associated with the pacing/sensing that would normally be seen by a dedicated ring electrode of a standard lead but is instead seen by the distal coil 24 of the integrated bipolar high voltage lead 10 of FIG. 1. The middle ring contact 2b is part of the RV shock circuit of the pulse generator 20 and sees the electrical signals associated with the cardioverting and/or defibrillating shocking that would normally be seen by a dedicated RV shock coil of a standard lead but is instead seen by the distal coil 24 of the integrated bipolar high voltage lead 10 of FIG. 1. The distal ring contact 2c is part of the SVC shock circuit of the pulse generator 20 and sees the electrical signals associated with the cardioverting and/or defibrillating shocking that is seen by the SVC shock coil (i.e., proximal shock coil 25) of the integrated bipolar high voltage lead 10 of FIG. 1.

As indicated in FIG. 4, the proximal ring contact 2a and the middle ring contact 2b are electrically connected, the electrical connection 70 serving as an electrical shunt 70 between the pacing/sensing circuit, of which the proximal ring contact 2a is a part, and the RV shock circuit, of which the middle ring contact 2b is a part. Because of the electrical shunt 70 between these two circuits, the pacing/sensing signals and the RV shock signals can be administered through a common electrode, which in this case is the distal coil 24. Where the pin conductors 33 are employed as the conductors 32 in the lead connector end 18, the shunt 70 may be the first pin conductor 32a that is welded or otherwise electrically and mechanically directly connected to both the proximal ring contact 2a and the middle ring contact 2b. Thus, an internal and integral shunt assembly is formed by the electrical and mechanical direct connection of the proximal ring contact 2a to the middle ring contact 2b via the first pin conductor 33a or another type of first conductor 32a such as, for example, a wire or multi-filar cable conductor 35a.

The shunt 70 disclosed herein electrically connects the ring contact 2b that is part of the RV shock circuit to the ring contact 2a that is part of the RV sensing/pacing circuit that would normally be coupled to a ring electrode of a standard lead. In one embodiment, the middle ring contact 2b is configured with dual electrical connection arrangements for respectively electrically and mechanically connecting to the first electrical conductor 32a and the second electrical conductor 32b. As a result, continuity between the ring electrode circuit and the RV coil circuit is accomplished via the shunt 70.

In the integrated bipolar lead 10, the ring electrode is eliminated and the termination crimp ring is welded directly to the RV shock coil 24. Internal lead body symmetry is maintained by still employing a conductor cable 35a positioned in the ring electrode cable lumen and extending from the ring electrode ring contact 2a on the proximal end to a point near, but not contacting, the RV shock coil 24 on the distal end. Specifically, as discussed above in one embodiment, the proximal end of the cable conductor 35a is welded and crimped to the distal end of the pin conductor 32a, which extends from the pin conductor's connections to the proximal ring contact (RV ring electrode ring contact) 2a and the middle ring contact (RV shock coil ring contact) 2b. Thus, since the lead body 12, boot 21 and connector body 30 still employ all of the conductors that would be used were the RV electrode and RV shock coil not integrated into the RV shock coil 24 (i.e., were the lead not an integrated bi-polar lead), the lead body, boot and connector body 30 maintain the same symmetry. Also, the same lead body stringing processes can be employed, despite the use of an IS4/DF4 connector 18 and an integrated bi-polar lead configuration.

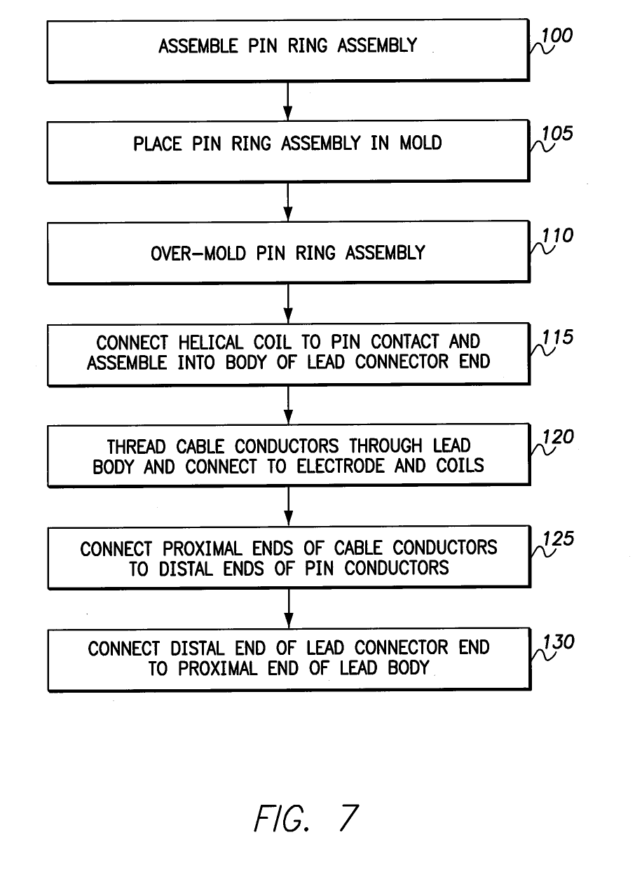

In one embodiment, the integrated bi-polar lead 10 can be assembled as described below with respect to FIG. 7, which is a flow chart of the process. The pin ring assembly is assembled [block 100]. Specifically, the proximal ring contact 2a, the middle ring contact 2b and the distal ring contact 2c are provided and arranged as shown in FIG. 4. The first pin conductor 33a is arranged to extend through the open center regions of each of the ring contacts 2a, 2b, 2c and electrically and mechanically directly connected to the proximal ring contact 2a and the middle ring contact 2b. The second pin conductor 33b is arranged to extend through the open center regions of each of the ring contacts 2b, 2c and electrically and mechanically directly connected to the middle ring contact 2b. The third pin conductor 33c is arranged to extend through the open center region of each of the ring contact 2c and electrically and mechanically directly connected to the distal ring contact 2c. The pin ring assembly is now complete and appears as shown in FIG. 4.

The pin ring assembly of FIG. 4 is placed in a mold [block 105]. The pin ring assembly is over-molded to form the body 30 of the ring connector end 18 about the pin ring assembly such that the ring connector end 18 appears as shown in FIG. 4 were the phantom lines of the connector body 30 shown in solid lines [block 110]. The pin contact 3 is connected to the helical coil 34 and assembled into the lead connector end 18 as shown in FIG. 3 [block 115]. The conductor cables 35 are thread through the lumens of the lead body 12 and connected to the electrode and shock coils [block 120]. The proximal ends of the conductor cables 35 are connected to the distal ends of the conductor pins 33 [block 125]. The proximal end of the lead body is connected to the distal end of the lead connector end [block 130].

The internal shunt 70 of the lead connector end 18 disclosed herein allows electrical continuity to be achieved between the proximal ring contact 2a and the middle ring contact 2b. The lead connector end 18 provides a number of advantages. First, the shunt connection 70 is over-molded and protected both within the lead connector end 18 and the header of the pulse generator 20 when the lead connector end is plugged into the header.

Second, by incorporating the shunt 70 into the lead connector end 18, a symmetric lead body and connector boot can be maintained. A symmetrical lead body provides advantages clinically so that there are no flex planes with higher stresses on internal components, which is a problem seen with lead body designs known in the art. Symmetric designs also have advantages for mechanical testing such as lead body and connector flex, since orientation of the lead in test equipment is not necessary, hence testing in multiple orientations is not required. Symmetric designs also have advantages in assembly allowing nearly identical steps as that used for a true bi-polar lead assembly.

Third, the internal shunt 70 provides a solution for manufacturing an integrated bi-polar high voltage, IS4/DF4 lead.

Although the present invention has been described with reference to preferred embodiments, persons skilled in the art will recognize that changes may be made in form and detail without departing from the spirit and scope of the invention.

What is claimed is:

1. A method of manufacturing a lead connector end of an implantable medical lead, the method comprising:
providing a first ring contact, a second ring contact and a third ring contact in a spaced apart arrangement, each of the ring contacts generally centered about a common longitudinal axis;
providing a first conductor, a second conductor and a third conductor;
assembling a ring assembly by causing: 1) the first conductor to be electrically and mechanically directly connected to both of the first ring contact and the second ring contact; 2) the second conductor to be electrically and mechanically directly connected to the second ring contact; and 3) the third conductor to be electrically and mechanically directly connected to the third ring contact; and
over-molding the assembled ring assembly to form a body of the lead connector end.

2. The method of claim 1, wherein at least one of the first, second or third conductor includes a pin conductor.

3. The method of claim 1, wherein at least one of the first, second and third conductor is a wire or multi-filar conductor.

4. The method of claim 1, wherein the first ring contact, the second ring contact and the third ring contact are, respectively, a proximal ring contact, a middle ring contact and a distal ring contact.

5. The method of claim 1, wherein the first ring contact, the second ring contact and the third ring contact are, respectively, a RV electrode ring contact, a RV shock coil ring contact and a SVC shock coil ring contact.

6. The method of claim 1, wherein assembling the ring assembly further includes causing each of the conductors to extend into a center region of at least one of the conductors.

7. The method of claim 1, wherein electrically and mechanically directly connecting the first conductor to the first ring contact includes at least one of welding, brazing, soldering or crimping the first conductor directly to at least a portion of the first ring contact.

8. The method of claim 7, wherein the at least a portion of the first ring contact includes a member radially inwardly projecting into a center region of the first ring contact.

9. The method of claim 1, wherein the body is a body for an IS4 or DF4 lead connector end.

10. An implantable integrated bi-polar medical lead comprising:
a tubular body including a distal end and a proximal end;
a distal shock coil supported on the tubular body proximal of the distal end;
a proximal shock coil supported on the tubular body proximal the distal shock coil;
a lead connector end including a cylindrical body with a proximal end and a distal end, the lead connector end further including three ring contacts imbedded in the cylindrical body and longitudinally spaced apart from each other along the cylindrical body, the distal end of the lead connector end being coupled to the proximal end of the tubular body;
a first conductor extending through the tubular body and lead connector end and directly electrically connected to two ring contacts of the three ring contacts; and
a second conductor extending through the tubular body and lead connector end and directly electrically connected to the distal shock coil and one ring contact of the two ring contacts.

11. The lead of claim 10, further comprising a third conductor extending through the tubular body and lead connector end and directly electrically connected to the proximal shock coil and one ring contact that is not the two ring contacts of the three ring contacts.

12. The lead of claim 11, wherein the two ring contacts of the three ring contacts are a proximal ring contact and a middle ring contact, the one ring contact of the two ring contacts is the middle ring contact, and the one ring contact that is not the two ring contacts of the three ring contacts is a distal ring contact.

13. The lead of claim 11, wherein the two ring contacts of the three ring contacts are a RV electrode ring contact and a RV shock coil ring contact, the one ring contact of the two ring contacts is the RV shock coil ring contact, and the one ring contact that is not the two ring contacts of the three ring contacts is a SVC shock coil ring contact.

14. The lead of claim 10, wherein the distal shock coil is configured to act as both a RV ring electrode and a RV shock electrode.

15. The lead of claim 10, wherein the first conductor directly electrically connecting to the two ring contacts of the three ring contacts forms an internal electrical shunt between the two ring contacts of the three ring contacts.

16. The lead of claim 10, wherein the first conductor includes: a single wire conductor or multi-filar cable conductor extending through the tubular body;
and a conductor pin extending through the lead connector end, a distal end of the conductor pin being connected to a proximal end of the single wire conductor or multi-filar conductor.

17. The lead of claim 10, wherein the lead connector is at least similar to an IS4 or DF4 lead connector end.

18. The lead of claim 10, further comprising: a tip electrode near a distal end of the tubular body; a pin contact proximally extending from a proximal end of the lead connector end; and a helical coil conductor extending between the tip electrode and the pin contact.

19. A lead connector end comprising:
a generally cylindrical body of unitary construction, the unitary construction including an electrically non-conductive material extending between three ring contacts imbedded in the electrically non-conductive material, the three ring contacts being offset from each other along a longitudinal length of the unitary body; and
an electrical conductor extending between two of the three ring contacts and recessed within an outer circumferential surface of the generally cylindrical body of unitary construction.

20. The lead connector end of claim 19, wherein the electrical conductor including a pin conductor.

21. The lead connector end of claim 19, wherein the two of the three ring contacts are a proximal ring contact and a middle ring contact.

22. The lead connector end of claim 19, wherein the two of the three ring contacts are a RV ring electrode ring contact and a RV shock coil ring contact.

23. The lead connector end of claim 19, further comprising a pin contact extending proximally from a proximal end of the lead connector end.
